(19) United States
(12) Patent Application Publication
(10) Pub. No.: US 2012/0265793 A1
(43) Pub. Date: Oct. 18, 2012

(54) MERGED COMPRESSOR FLOP CIRCUIT

(75) Inventors: George Q. PHAN, Fremont, CA (US); Scott A. HILKER, San Jose, CA (US)

(73) Assignee: ADVANCED MICRO DEVICES, INC., Sunnyvale, CA (US)

(21) Appl. No.: 13/085,305

(22) Filed: Apr. 12, 2011

(51) Int. Cl. G06F 7/487; G06F 17/50

(52) U.S. Cl. 708/203; 700/97

(57) ABSTRACT

A merged compressor flip-flop circuit is provided. The circuit includes a compressor circuit having a front-end and a back-end, the front-end configured to receive four input bits and to output a first carry-bit to a back-end of a second compressor circuit, the front end further configured to output intermediate sum signals to the back-end of the compressor circuit, the back-end configured to receive the intermediate sum signals from the front-end and further configured to receive a second carry-bit from a front-end of a third compressor circuit, the back-end further configured to output a sum-bit and a third carry-bit based upon the intermediate sum signals and the second carry-bit, and a flip-flop circuit configure to receive the sum-bit and third carry-bit and to store the sum-bit and third carry-bit, wherein the back-end of the compressor circuit directly drives the sum-bit and third carry-bit into the flip-flop circuit

### TECHNICAL FIELD

The present disclosure generally relates to a floating point multiplier circuit in a processor, and more particularly to a floating point multiplier circuit using a merged compressor flop circuit.

### BACKGROUND

Modern processors, such as central processing units (“CPU's”) and graphical processing units (“GPU's”), are generally capable of implementing a floating point multiplication calculation. The term floating point refers to the fact that the radix point (decimal point, or, more commonly in computers, binary point) can “float”; that is, it can be placed anywhere relative to the significant digits of the number. Floating point calculations typically take at least three clock cycles for the processor to perform. Furthermore, the processor requires large numbers of circuit elements to perform the floating point calculation which can take up a large amount of space on the processor and can use a large amount of power.

### BRIEF SUMMARY OF EMBODIMENTS

In order to improve the performance of a floating point calculation in a processor, as well as to reduce the area required by the floating point multiplier and reduce the amount of power consumed thereby, a merged compressor flip-flop circuit is used.

A merged compressor flip-flop circuit is provided, the merged compressor flip-flop circuit includes a compressor circuit having a front-end and a back-end, the front-end configured to receive four input bits and to output a first carry-bit to a back-end of a second compressor circuit, the front end further configured to output intermediate sum signals to the back-end of the compressor circuit, the back-end configured to receive the intermediate sum signals from the front-end and further configured to receive a second carry-bit from a front-end of a third compressor circuit, the back-end further configured to output a sum-bit and a third carry-bit based upon the intermediate sum signals and the second carry-bit, and a flip-flop circuit configure to receive the sum-bit and third carry-bit and to store the sum-bit and third carry-bit, wherein the back-end of the compressor circuit directly drives the sum-bit and third carry-bit into the flip-flop circuit.

A processor including a floating point multiplier circuit is provided. The processor includes a plurality of merged compressor latch circuits. Each of the merged compressor latch circuits include a compressor circuit comprising a front-end and a back-end, the front-end configured to receive four input bits and to output a first carry-bit to a back-end of a compressor circuit in a second merged compressor latch circuit, the front end further configured to output intermediate sum signals to the back-end of the compressor circuit, the back-end configured to receive the intermediate sum signals from the front-end and further configured to receive a second carry-bit from a front-end of a compressor circuit of a third merged compressor latch circuit, the back-end further configured to output a sum-bit and a third carry-bit based upon the intermediate sum signals and the second carry-bit, and a latch circuit configure to receive the sum-bit and third carry-bit and to store the sum-bit and third carry-bit, wherein the back-end of the compressor circuit directly drives the sum-bit and third carry-bit into the latch circuit.

A computer-readable medium having computer-executable instructions or data stored thereon that, when executed, facilitate fabrication of a semiconductor device is provided. The semiconductor device includes a compressor circuit having a front-end and a back-end, the front-end configured to receive four input bits and to output a first carry-bit to a back-end of a second compressor circuit, the front end further configured to output intermediate sum signals to the back-end of the compressor circuit, the back-end configured to receive the intermediate sum signals from the front-end and further configured to receive a second carry-bit from a front-end of a third compressor circuit, the back-end further configured to output a sum-bit and a third carry-bit based upon the intermediate sum signals and the second carry-bit, and a latch circuit configure to receive the sum-bit and third carry-bit and to store the sum-bit and third carry-bit, wherein the back-end of the compressor circuit directly drives the sum-bit and third carry-bit into the latch circuit.

### BRIEF DESCRIPTION OF THE DRAWINGS

The present embodiments will hereinafter be described in conjunction with the following figures.

FIG. 1 is an exemplary merged compressor flip-flop circuit in accordance with an embodiment;

FIG. 2 is an exemplary front-end of the compressor illustrated in FIG. 1 in accordance with an embodiment;

FIG. 3 is an exemplary XOR gate for that may be used in the front-end of the compressor illustrated in FIG. 1 in accordance with an embodiment;

FIG. 4 is another exemplary XOR gate for that may be used in the front-end of the compressor illustrated in FIG. 1 in accordance with an embodiment;

FIG. 5 is an exemplary back-end of the compressor illustrated in FIG. 1 in accordance with an embodiment; and

FIG. 6 is an exemplary processor including a floating point multiplier using a merged compressor flip-flop circuit in accordance with an embodiment;

FIG. 7 is an exemplary flip-flop in accordance with an embodiment; and

FIG. 8 is an exemplary latch in accordance with an embodiment.

### DETAILED DESCRIPTION OF THE DRAWINGS

The following detailed description of embodiments is merely exemplary in nature and is not intended to limit the embodiments or the application and uses of the embodiments. Furthermore, there is no intention to be bound by any theory presented in the preceding background or the following detailed description.

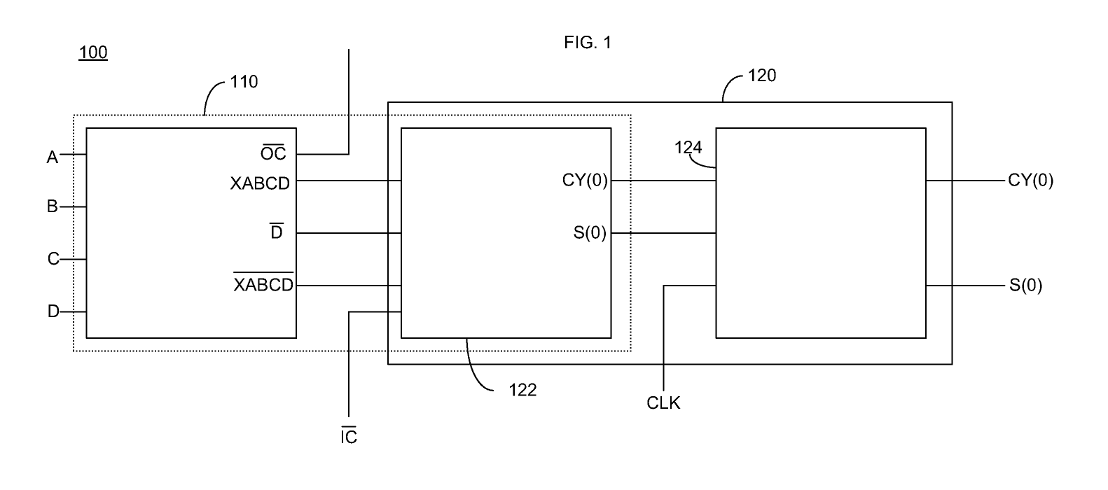

FIG. 1 illustrates an exemplary merged compressor flop circuit 100. The circuit 100 may be part, for example, of a floating point multiplier circuit in a processor (not illustrated). The circuit 100 includes a compressor circuit 110 and a flip-flop circuit 120. A front end 122 of the flip-flop circuit 120 also doubles as the back end of the compressor circuit 110, performing the last stage of a sum and carry calculation and directly driving the results into a back-end 124 of the flip-flop circuit 120 as discussed in further detail below. In other embodiments, for example, a latch circuit may be used instead of flip-flop 120, as discussed in further detail below.

The compressor circuit 110 receives four single-bit inputs A-D and outputs a signal XABCD. The signal XABCD is the output of the equation: (A⊕B)⊕(C⊕D), where “⊕” symbolizes an exclusive OR (“XOR”) operation. Any combination of logic gates may be used to generate the signal XABCD. The compressor circuit 110 also outputs an inverse carry-bit O̅C̅ which may be passed onto another circuit 100 as discussed in further detail below. The inverse carry-bit O̅C̅ represents that at least two of inputs from any three of the input bits, for example A-C, are a logical one. When any two of the inputs are a logical one, the sum of the inputs will be at least two which is at least a two bit number (i.e., “10”). Accordingly, the carry-bit O̅C̅ represents that the sum of inputs A-D are greater than or equal to two. As discussed in further detail below, the carry-bit O̅C̅ in input into a front-end 122 of another flip-flop circuit 120. Any combination of three of the four input bits may be used to generated the carry-bit O̅C̅. The compressor circuit 110 also outputs the inverse of the signal XABCD (i.e., X̅A̅B̅C̅D̅) and the inverse of the bit not used to generate the carry-bit O̅C̅, which are used to generate the sum of the inputs A-D as discussed in further detail below. For example, if inputs A-C are used to generate the carry-bit O̅C̅, the compressor circuit 110 will output the inverse of the D input (i.e., a D̅ signal).

The signals XABCD, X̅A̅B̅C̅D̅ and D̅ are transmitted to the input of the front-end 122 of the flip-flop circuit 120 and may be called intermediate sum signals. The front-end 122, when connected to a series of circuits 100 in a multiplier configuration, may also receive a signal I̅C̅ representing a carry-bit from another circuit 100. The signal I̅C̅ (which is output from another circuit 100 as the signal O̅C̅) represents that a sum of a different four bits input into another circuit 100 is greater than or equal to two, as discussed in further detail below. The front-end 122 determines a sum-bit S(0) and a carry-bit CY(0) of the inputs A-D based upon the received signals XABCD, X̅A̅B̅C̅D̅, D̅ and I̅C̅ and directly drives the sum-bit S(0) and carry-bit CY(0) to the back-end 124 of the flip-flop 120. The front-end 122 should output the sum-bit and carry-bit to the flip-flop 120 with a significant enough voltage to allow the flip-flop to latch the respective signals without needing a separate driving circuit. The flip-flop 120 may save the input sum-bit s(0) and carry-bit CY(0) for a second stage of the floating point multiplier circuit.

While the circuit 100 receives four input bits A-D and outputs a sum-bit and carry-bit like a traditional 4:2 compressor circuit, the circuit 100 also outputs a carry-bit O̅C̅ which may be used by the front-end 122 of second flip-flop circuit 120 for a second circuit 100. The circuit 100 can also receives an input carry-bit I̅C̅ from a compressor circuit 110 of a third circuit 100 as illustrated in further detail below. Accordingly, the circuit 100 may be considered a 5:3 compressor circuit. By incorporating the input carry-bit I̅C̅ from another circuit 100 into the calculation of the sum-bit S(0) and carry-bit CY(0), in addition to implementing some of the other circuitry illustrated herein, a processor using the circuit 100 in a floating point multiplier can accomplish the floating point multiplication calculation in as few as two clock cycles. In contrast, prior floating point multiplier circuits using traditional 4:2 compressors needed at least three clock cycles to perform a floating point multiplication. Accordingly, the performance of a multiplier circuit using the circuit 100 may be improved.

Another advantage of the embodiment illustrated in FIG. 1 is that since the output of the front-end 122 of the flip-flop 120 is used to directly drive the back-end 124 of the flip-flop circuit 120 the circuit 100, additional driver circuitry is not needed. In contrast, prior multiplier circuits used a separate driver to drive output from a traditional 4:2 compressor into a flip-flop. Accordingly, another advantage of the embodiment is that less area is needed for the multiplier circuit in a processor and less power is dissipated when the multiplier circuitry is used.

While the embodiments described herein suggest using a flip-flop to hold the output of the circuit 100, other latch circuitry may be used. For example, a transparent latch may be used.

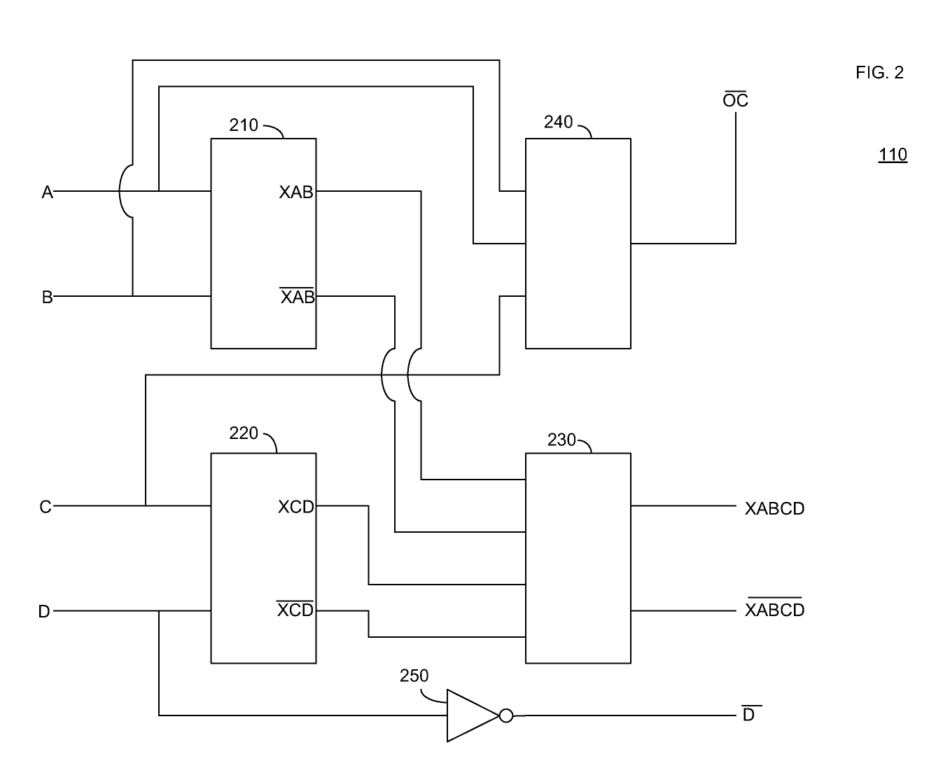

FIG. 2 illustrates an exemplary compressor circuit 110. The compressor circuit 110 includes a first XOR gate 210, a second XOR gate 220 and a third XOR gate 230. XOR gate 210 receives two inputs, for example, bit-A and bit-B, and outputs the exclusive OR of the input signals, i.e., XAB. The XOR gate 210 also generates an inverse of the output signal, i.e., X̅A̅B̅. Likewise, XOR gate 220 receives the other two input bits, in this example bit-C and bit-D and outputs the exclusive OR of the input signals, i.e., X̅C̅D̅. The XOR gate 220 likewise generates the inverse of the output signal, i.e., X̅C̅D̅. Table 1 below is a truth table illustrating the output generated from any one of the XOR gates 210-230.

TABLE 1

| Input 1 | Input 2 | Output | O̅u̅t̅p̅u̅t̅ |
|---|---|---|---|
| 0 | 0 | 0 | 1 |
| 0 | 1 | 1 | 0 |
| 1 | 0 | 1 | 0 |
| 1 | 1 | 0 | 1 |

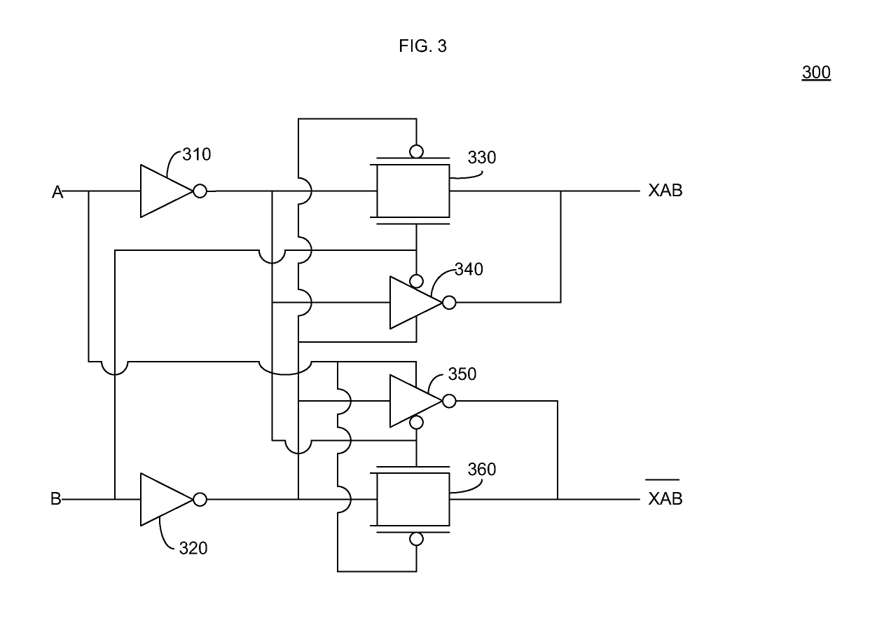

FIG. 3 illustrates an exemplary XOR gate 300 which may be used for XOR gates 210 and 220. The XOR gate 300 includes a first inverter 310 receiving a first input, for example, input A as illustrated in FIG. 3, and a second inverter 320 receiving a second input, for example, input B as illustrated in FIG. 3. The XOR gate further includes pass gates 330 and 360 and tri-state inverters 340 and 350. The pass gates 330 and 360 may each include, for example, a p-channel cmos transistor coupled to an n-channel cmos transistor as illustrated in FIG. 3. Pass gate 330 is controlled by the input B and the inverse of input B output from inverter 320. Likewise, Pass gate 360 is controlled by the input A and the inverse of input A output from inverter 310. If pass gate 330 is disabled by the respective input signals, tri-state inverter 340 is enabled and outputs a signal corresponding to the XOR of the first and second input signals, in this example, XAB. Likewise, if pass gate 360 is disabled by the respective input signals, tri-state inverter 350 is enabled and outputs a signal corresponding to the inverse of the XOR of the first and second input signals, in this example, X̅A̅B̅.

Returning to FIG. 2, the signals output from XOR gates 210 and 220 (XAB, X̅A̅B̅, XCD and X̅C̅D̅) are received as input at the XOR gate 230. The XOR gate 230, based upon the received signals, outputs the signals XABCD and X̅A̅B̅C̅D̅, representing the exclusive OR of the signals XAB and XCD and the inverse thereof, respectively.

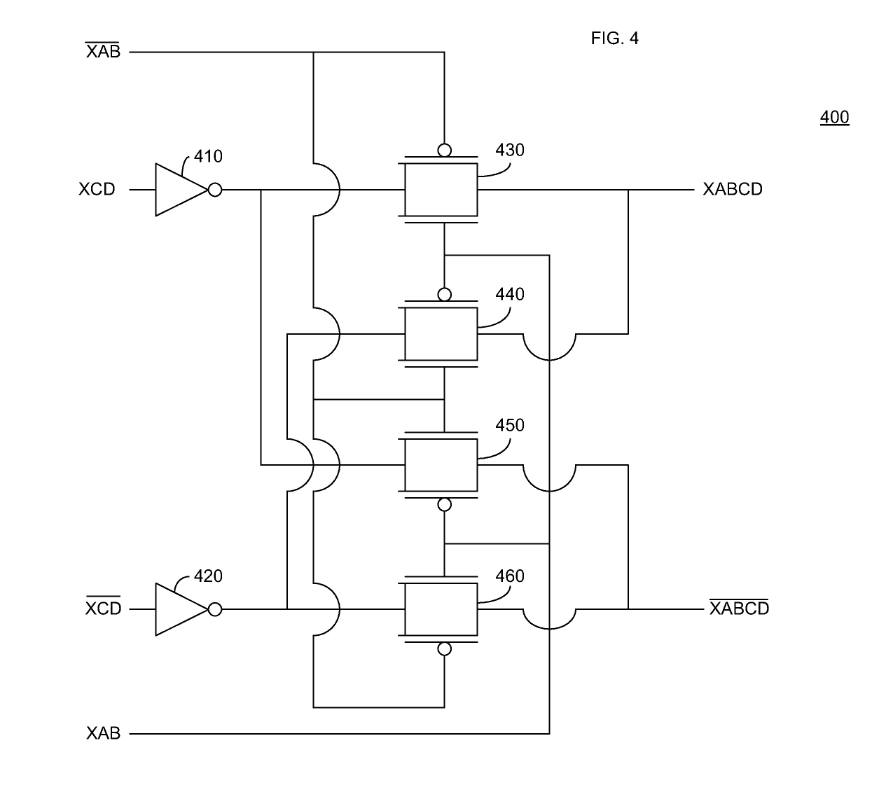

FIG. 4 illustrates an exemplary XOR gate 400 which may be used for XOR gate 230. XOR gate 400 includes inverters 410-420 and pass gates 430-460. Inverter 410 receives a first input, in this example XCD, and inverter 420 receives a second input, in this example X̅C̅D̅. Pass gates 430-460 are enabled and disabled based upon a third and fourth input signal to the XOR gate 400, in this example, signals XAB and X̅A̅B̅. Pass gate 430 receives the output from inverter 410 and, if enabled, output the signal corresponding to XABCD. Pass gate 440 receives the output from inverter 420. When the pass gate 430 is disabled by the input signals, pass gate 440 is enabled and is configured to output the signal corresponding to XABCD. Pass gate 460 receives an input from inverter 420 and, if enabled, output the signal corresponding to X̅A̅B̅C̅D̅. Pass gate 450 also receives the output from inverter 410. When the pass gate 460 is disabled by the input signals, pass gate 440 is enabled and is configured to output the signal corresponding to X̅A̅B̅C̅D̅.

Returning to FIG. 2, the compressor circuit 110 also includes a majority gate 240. The majority gate 240 outputs a signal representative that at least two of the three input bits are logical ones. The majority gate may be built constructed from any combination of logic gates. In one embodiment, for example, an AND 2 OR 3 circuit may be used. Table 2 illustrates the input/output for the majority gate 240.

TABLE 2

| Input 1 | Input 2 | Input 3 | Output | O̅u̅t̅p̅u̅t̅ |
|---|---|---|---|---|
| 0 | 0 | 0 | 0 | 1 |
| 0 | 0 | 1 | 0 | 1 |
| 0 | 1 | 0 | 0 | 1 |
| 0 | 1 | 1 | 1 | 0 |
| 1 | 0 | 0 | 0 | 1 |
| 1 | 0 | 1 | 1 | 0 |
| 1 | 1 | 0 | 1 | 0 |
| 1 | 1 | 1 | 1 | 0 |

The inverse output of the majority gate 240 is used as the inverse carry-bit O̅C̅ discussed above. While the embodiments described herein use the inverse output of the majority gate 240, one of ordinary skill in the art would recognize that other configurations may be implemented to use a non-inversed carry-bit.

The compressor circuit 110 also includes an inverter 250 which inverts the input not received by the majority gate 240. As seen in FIG. 2, inputs A-C are received by the majority gate 240 and input D is received by the inverter 250. As discussed above, any combination of three of the inputs A-D can be transmitted to the majority gate 240, with the fourth bit being transmitted to the inverter 250.

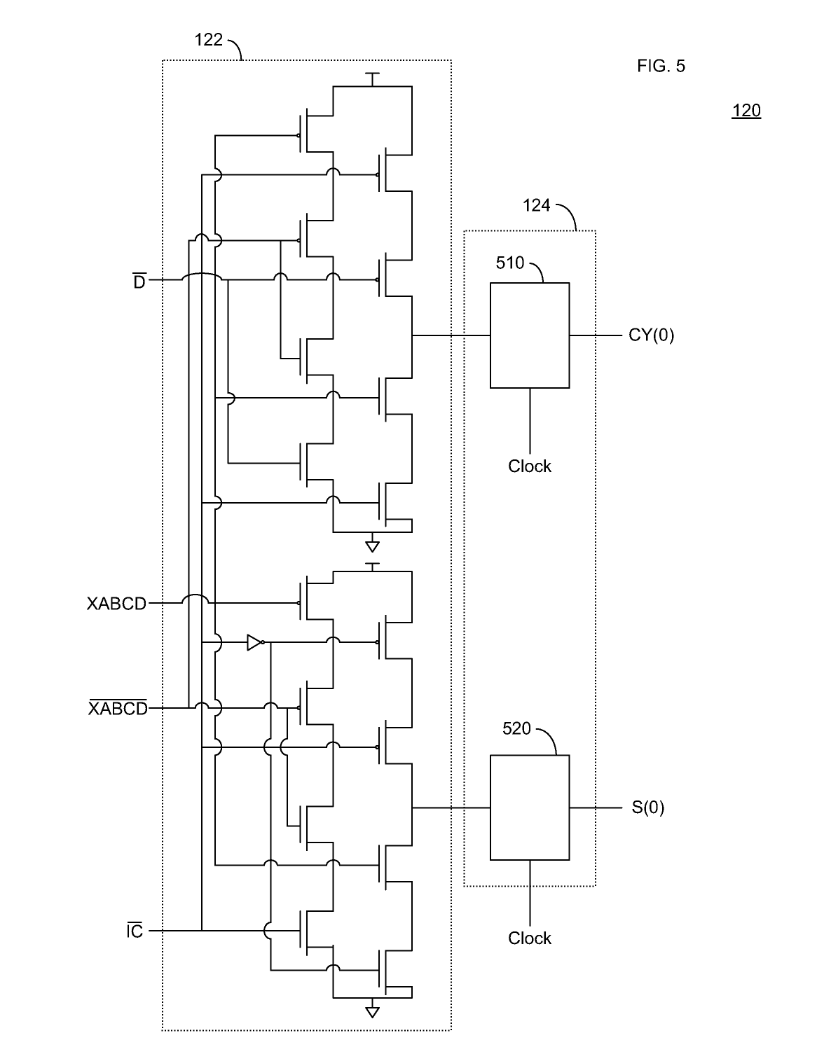

FIG. 5 illustrates an exemplary flip-flop circuit 120 illustrated in FIG. 1. As discussed above, the front end 122 of flip-flop 120 also doubles as the back-end of the compressor by performing the last sum XOR stage needed to calculate the final sum and carry outputs. The flip-flop 120 receives the signals XABCD, X̅A̅B̅C̅D̅, and D̅ from the compressor circuit 110. The flip-flop may also receive a carry-bit I̅C̅ from another circuit 100 as discussed in further detail below. The exemplary front end 122 includes a single stage AND2-OR2-Invert circuit. One benefit of the embodiment illustrated in FIG. 5 is that the front end 122 has enough gain to directly drive output to the back end 124. In other embodiments, the front end 122 may be a two-stage NAND2 circuit or any other combination of logic circuits.

The back-end 124 of flip-flop 120 illustrated in FIG. 5 also includes two flip-flop circuits 510 and 520. Flip-flop circuits 510 and 520 latch on to the output of the signals CY(0) and S(0), respectively, based upon the Clock signal.

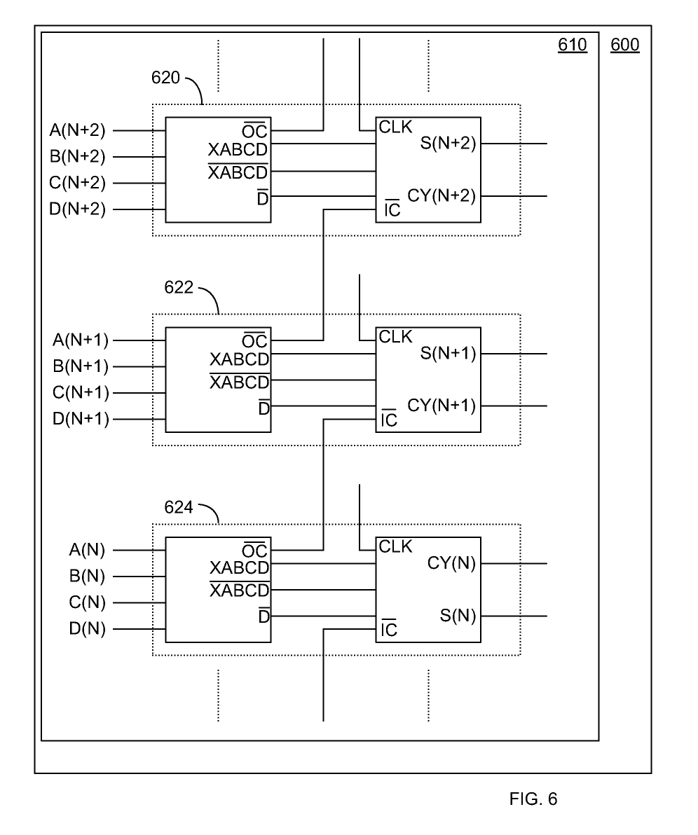

FIG. 6 illustrates an exemplary portion of a floating point multiplier circuit 610 for a processor 600. The front end 610 includes a plurality of merged compressor flop circuits 620-624. As discussed above, each of the merged compressor flop circuits 620-624 receives four input bits (A(N)−D(N) to A(N+X)−D(N+X)), where X is the number of merged compressor flop circuits in the floating point multiplier circuit 610. Further, each of the merged compressor flop circuits 620-624 receives a carry-bit I̅C̅ from a neighboring merged compressor flop circuit. For example, as seen in FIG. 6, circuit 622 receives an input carry-bit signal I̅C̅ from circuit 624. Likewise, each of the compressor flop circuits 620-624 outputs a carry-bit signal O̅C̅ (received as I̅C̅). Furthermore, each of the merged compressor flop circuits 620-624 outputs a corresponding sum-bit S(N) and a carry-bit CY(N). Table 3 is a truth table illustrating the exemplary operation of each of the compressor flop circuits 620-624 for the floating point multiplier circuit 610 illustrated in FIG. 6.

TABLE 3

| ABCD | I̅C̅ | XAB | XCD | XABCD | X̅A̅B̅C̅D̅ | O̅C̅ | S(N) | CY(N) | Carries |
|---|---|---|---|---|---|---|---|---|---|
| 0000 | 0 | 0 | 0 | 0 | 1 | 1 | 1 | 0 | 0 |
| 0000 | 1 | 0 | 0 | 0 | 1 | 1 | 0 | 0 | 0 |
| 0001 | 0 | 0 | 1 | 1 | 0 | 1 | 0 | 1 | 1 |
| 0001 | 1 | 0 | 1 | 1 | 0 | 1 | 1 | 0 | 0 |
| 0010 | 0 | 0 | 1 | 1 | 0 | 1 | 0 | 1 | 1 |
| 0010 | 1 | 0 | 1 | 1 | 0 | 1 | 1 | 0 | 0 |
| 0011 | 0 | 0 | 0 | 0 | 1 | 1 | 1 | 1 | 1 |
| 0011 | 1 | 0 | 0 | 0 | 1 | 1 | 0 | 1 | 1 |
| 0100 | 0 | 1 | 0 | 1 | 0 | 1 | 0 | 1 | 1 |
| 0100 | 1 | 1 | 0 | 1 | 0 | 1 | 1 | 0 | 0 |
| 0101 | 0 | 1 | 1 | 0 | 1 | 1 | 1 | 1 | 1 |
| 0101 | 1 | 1 | 1 | 0 | 1 | 1 | 0 | 1 | 1 |
| 0110 | 0 | 1 | 1 | 0 | 1 | 0 | 1 | 0 | 1 |
| 0110 | 1 | 1 | 1 | 0 | 1 | 0 | 0 | 0 | 1 |
| 0111 | 0 | 1 | 0 | 1 | 0 | 0 | 0 | 1 | 2 |
| 0111 | 1 | 1 | 0 | 1 | 0 | 0 | 1 | 0 | 1 |
| 1000 | 0 | 1 | 0 | 1 | 0 | 1 | 0 | 1 | 1 |
| 1000 | 1 | 1 | 0 | 1 | 0 | 1 | 1 | 0 | 0 |
| 1001 | 0 | 1 | 1 | 0 | 1 | 1 | 1 | 1 | 1 |
| 1001 | 1 | 1 | 1 | 0 | 1 | 1 | 0 | 1 | 1 |
| 1010 | 0 | 1 | 1 | 0 | 1 | 0 | 1 | 0 | 1 |
| 1010 | 1 | 1 | 1 | 0 | 1 | 0 | 0 | 0 | 1 |
| 1011 | 0 | 1 | 0 | 1 | 0 | 0 | 0 | 1 | 2 |
| 1011 | 1 | 1 | 0 | 1 | 0 | 0 | 1 | 0 | 1 |
| 1100 | 0 | 0 | 0 | 0 | 1 | 0 | 1 | 0 | 1 |
| 1100 | 1 | 0 | 0 | 0 | 1 | 0 | 0 | 0 | 1 |
| 1101 | 0 | 0 | 1 | 1 | 0 | 0 | 0 | 1 | 2 |
| 1101 | 1 | 0 | 1 | 1 | 0 | 0 | 1 | 0 | 1 |
| 1110 | 0 | 0 | 1 | 1 | 0 | 0 | 0 | 1 | 2 |
| 1110 | 1 | 0 | 1 | 1 | 0 | 0 | 1 | 0 | 1 |
| 1111 | 0 | 0 | 0 | 0 | 1 | 0 | 1 | 1 | 2 |
| 1111 | 1 | 0 | 0 | 0 | 1 | 0 | 0 | 1 | 2 |

As discussed above, the signals I̅C̅ and O̅C̅ are used as inverse signals in the embodiments described herein. Accordingly, an O̅C̅ of “0” indicates a carry-bit. As seen in Table 3 above, the merged compressor flop circuits 620-624 may output up to two carry-bits (i.e., a O̅C̅ of “0” and a CY(N) of “1”) depending upon the input bits A-D and the input carry-bit I̅C̅.

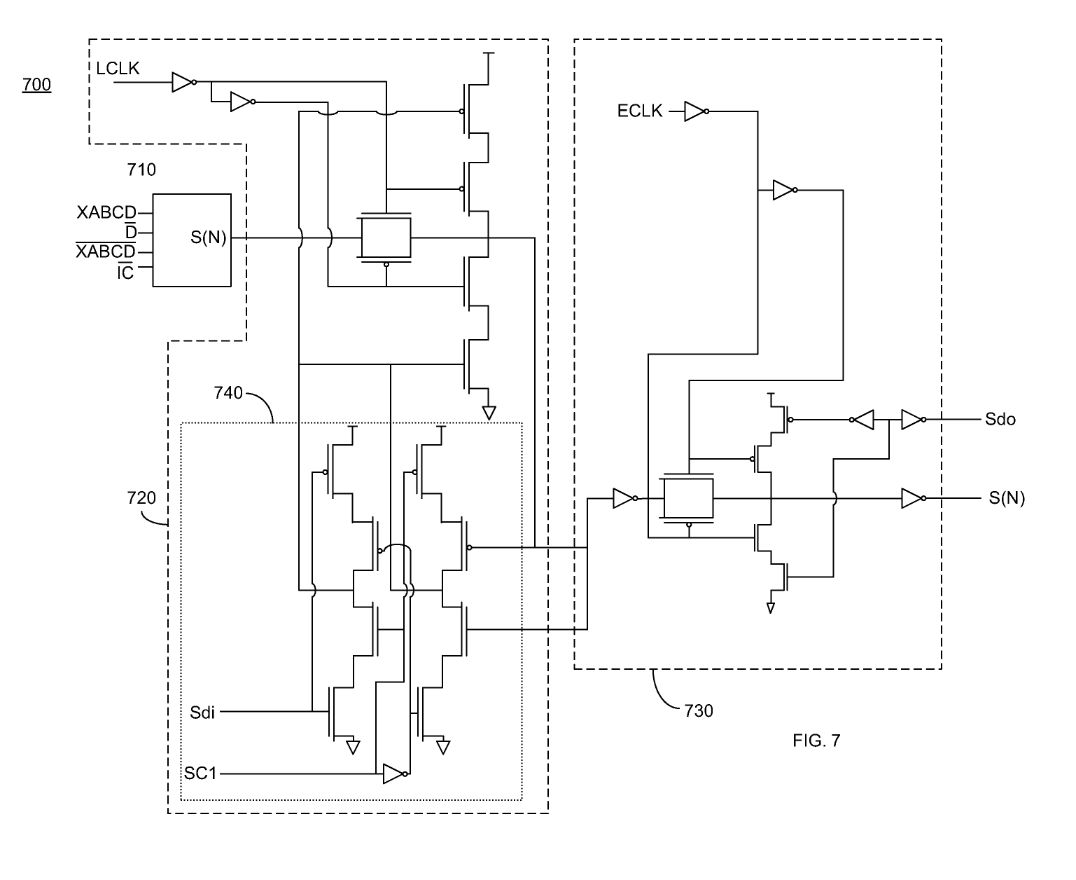

FIG. 7 illustrates an exemplary flip-flop 700 in accordance with an embodiment. As discussed above, the flip-flop 700 includes a front-end 710 which performs the last stage of a sum or carry calculation for the merged compressor flop circuit. The output of the front-end is directly driven into master flop circuit 720. Likewise, the output of the master flop circuit 720 is driven into a slave flop circuit 730. The flip-flop 700 may be caught by late clock LCLK and early clock ECLK. The flip-flop 700 may also include a scan circuitry 740.

The master flop circuit 720 and slave flop circuit 730 illustrated in FIG. 7 are merely an exemplary master-slave configuration. Other master-slave configurations and other types of flop-flop circuits may also be used.

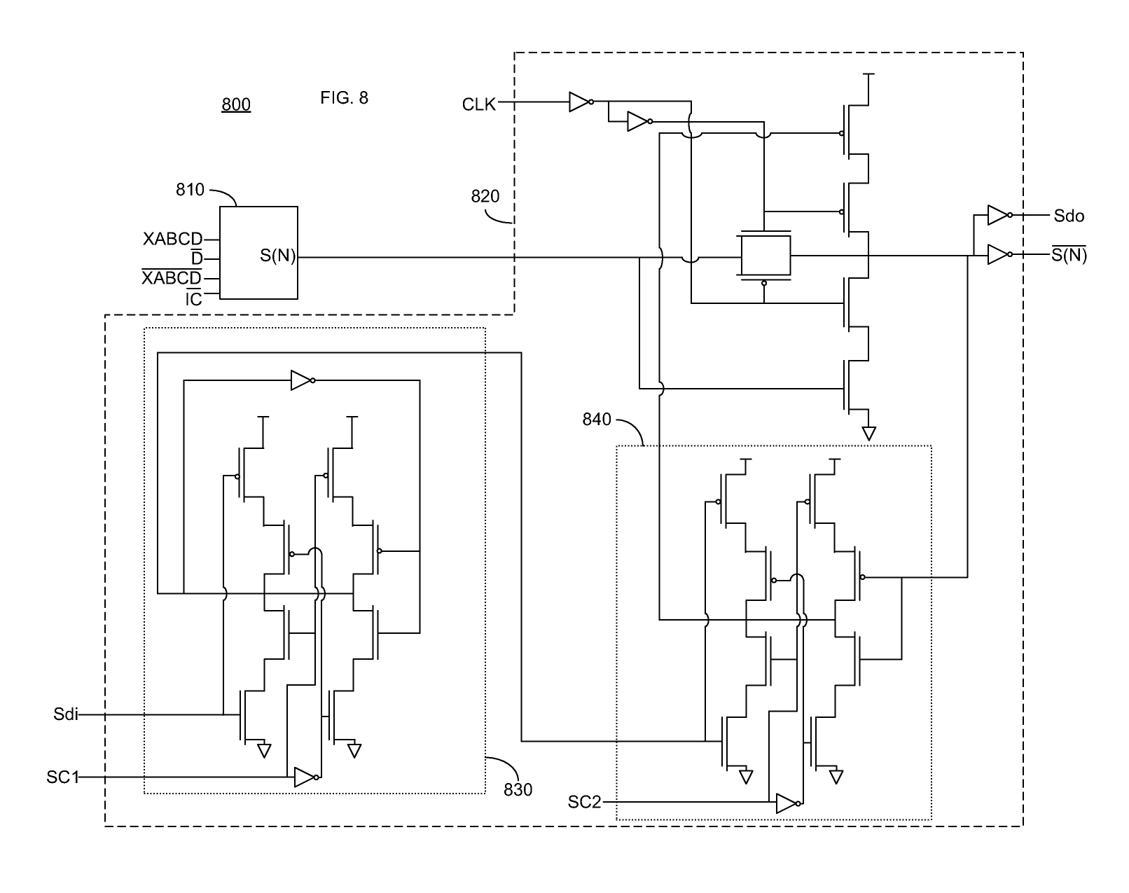

FIG. 8 illustrates an exemplary latch circuit 800 in accordance with an embodiment. As discussed above, a latch circuit may be used in place of a flip-flop to form a merged compressor-latch circuit. Similar to the flip-flop 700 illustrated in FIG. 7, the latch circuit 800 includes a front-end 810 which performs a last stage of a sum or carry calculation for the merged compressor latch circuit. The output of the front-end 810 is directly driven into a latching element 820 by the main circuit clock CLK. The latch may also include scan circuits 830 and 840 which may be used to test the latch 800.

The latching element 820 illustrated in FIG. 8 is merely an exemplary latching element. Other configurations and other types of latching elements may be used.

Physical embodiments of the subject matter described herein can be realized using existing semiconductor fabrication techniques and computer-implemented design tools. For example, hardware description language code, netlists, or the like may be utilized to generate layout data files, such as Graphic Database System data files (e.g., GDSII files), associated with various logic gates, standard cells and/or other circuitry suitable for performing the tasks, functions, or operations described herein. Such layout data files can be used to generate layout designs for the masks utilized by a fabrication facility, such as a foundry or semiconductor fabrication plant (or fab), to actually manufacture the devices, apparatus, and systems described above (e.g., by forming, placing and routing between the logic gates, standard cells and/or other circuitry configured to perform the tasks, functions, or operations described herein). In practice, the layout data files used in this context can be stored on, encoded on, or otherwise embodied by any suitable non-transitory computer readable medium as computer-executable instructions or data stored thereon that, when executed by a computer, processor, of the like, facilitate fabrication of the apparatus, systems, devices and/or circuitry described herein.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiments in any way. Rather, the foregoing detailed description will provide those skilled in the art with a convenient road map for implementing an exemplary embodiment. It being understood that various changes may be made in the function and arrangement of elements described in an exemplary embodiment without departing from the scope of the embodiments as set forth in the appended claims.

What is claimed is:

1. A circuit, comprising:
a compressor circuit having a front-end and a back-end, the front-end configured to receive input bits and to output a first carry-bit to a back-end of a second compressor circuit, the front end further configured to output intermediate sum signals to the back-end of the compressor circuit, the back-end configured to receive the intermediate sum signals from the front-end and further configured to receive a second carry-bit from a front-end of a third compressor circuit, the back-end further configured to output a sum-bit and a third carry-bit based upon the intermediate sum signals and the second carry-bit; and
a latch circuit configured to receive the sum-bit and third carry-bit and to store the sum-bit and third carry-bit,
wherein the back-end of the compressor circuit directly drives the sum-bit and third carry-bit into the flip-flop circuit.

2. The circuit of claim 1, wherein the front-end of the compressor circuit further comprises:
a first XOR gate configured to receive a first and second of the four input bits;
a second XOR gate configured to receive a third and fourth of the four input bits;
a third XOR gate configured to receive an output bit from the first XOR gate and an output bit from the second XOR gate;
a majority circuit configured to receive the first, second and third of the four input bits and to output the first carry-bit; and
an inverter receiving the fourth input bit.

3. The circuit of claim 2, wherein the first, second and third XOR gates each outputs a first signal corresponding to the XOR of respective input bits and a second signal corresponding to the inverse of the XOR of the respective input bits.

4. The circuit of claim 3, wherein the intermediate sum signals are the output of the third XOR gate and the output of the inverter.

5. The circuit of claim 1, wherein the back-end further comprises:
a first circuit to determine the sum-bit based upon the intermediate sum signals and the second carry-bit; and
a second circuit to determine the third carry-bit based upon the intermediate sum signals and the second carry-bit.

6. The circuit of claim 5, wherein the output of the sum-bit determined by the first circuit and the third carry-bit determined by the second circuit are directly input into the flip-flop circuit.

7. The circuit of claim 1, wherein the flip-flop circuit further comprises a first flip-flop configured to receive and store the sum-bit and a second flip-flop configured to receive and store the third carry-bit.

8. A processor including, comprising:
a plurality of merged compressor latch circuits, each of the plurality of merged compressor latch circuits comprising:
a compressor circuit comprising a front-end and a back-end, the front-end configured to receive four input bits and to output a first carry-bit to a back-end of a second compressor circuit in a second merged compressor latch circuit, the front end further configured to output intermediate sum signals to the back-end of the compressor circuit, the back-end configured to receive the intermediate sum signals from the front-end and further configured to receive a second carry-bit from a front-end of a third compressor circuit of a third merged compressor latch circuit, the back-end further configured to output a sum-bit and a third carry-bit based upon the intermediate sum signals and the second carry-bit; and
a latch circuit configured to receive the sum-bit and third carry-bit and to store the sum-bit and third carry-bit,
wherein the back-end of the compressor circuit directly drives the sum-bit and third carry-bit into the latch circuit.

9. The processor of claim 8, further comprising a floating point multiplier circuit wherein the floating point multiplier circuit performs a floating point multiplication calculation in two clock cycles.

10. The processor of claim 8, wherein the latch circuit is a flip-flop.

11. The processor of claim 8, wherein the latch circuit is a transparent latch.

12. The processor of claim 8, wherein the front-end of the compressor circuit further comprises:
a first XOR gate configure to receive a first and second of the four input bits;
a second XOR gate configure to receive a third and fourth of the four input bits;
a third XOR gate configure to receive an output bit from the first XOR gate and an output bit from the second XOR gate;
a majority circuit configure to receive the first, second and third of the four input bits and configured to output the first carry-bit; and
an inverter receiving the fourth input bit.

13. The processor of claim 12, wherein the first, second and third XOR gates output a first signal corresponding to the XOR of the respective input signals and a second signal corresponding to an inverse of the XOR of the respective input signals.

14. The processor of claim 12, wherein the intermediate sum signals are the output of the third XOR gate and the output of the inverter.

15. The processor of claim 8, wherein the back-end further comprises:
a first circuit to determine the sum-bit based upon the intermediate sum signals and the second carry-bit; and
a second circuit to determine the third carry-bit based upon the intermediate sum signals and the second carry-bit.

16. The processor of claim 15, wherein the output of the sum-bit determined by the first circuit and the third carry-bit determined by the second circuit are directly input into the latch circuit.

17. The processor of claim 8, wherein the latch circuit further comprises a first latch configured to receive and store the sum-bit and a second latch configured to receive and store the third carry-bit.

18. A computer-readable medium having computer-executable instructions or data stored thereon that, when executed, facilitate fabrication of a semiconductor device comprising:
a compressor circuit having a front-end and a back-end, the front-end configured to receive four input bits and to output a first carry-bit to a back-end of a second compressor circuit, the front end further configured to output intermediate sum signals to the back-end of the compressor circuit, the back-end configured to receive the intermediate sum signals from the front-end and further configured to receive a second carry-bit from a front-end of a third compressor circuit, the back-end further configured to output a sum-bit and a third carry-bit based upon the intermediate sum signals and the second carry-bit; and
a latch circuit configured to receive the sum-bit and third carry-bit and to store the sum-bit and third carry-bit,
wherein the back-end of the compressor circuit directly drives the sum-bit and third carry-bit into the latch circuit.

19. The computer-readable medium of claim 18, wherein the computer-executable instructions or data represent layout designs for photolithography masks utilized to fabricate the semiconductor device.

20. The computer-readable medium of claim 19, wherein the layout designs for the photolithography masks define the semiconductor device such that latch circuit is a flip-flop circuit.
